(19) United States
(12) Patent Application Publication
(10) Pub. No.: US 2014/0079240 A1
(43) Pub. Date: Mar. 20, 2014

(54) BLUETOOTH HEADSET

(71) Applicant: Samsung Electronics Co., Ltd., Gyeonggi-do (KR)

(72) Inventor: Hyun-Keun SON, Seoul (KR)

(73) Assignee: Samsung Electronics Co., Ltd., Gyeonggi-do (KR)

(21) Appl. No.: 14/024,930

(22) Filed: Sep. 12, 2013

(30) Foreign Application Priority Data
Sep. 14, 2012 (KR) 10-2012-0102407

(51) Int. Cl. H04R 1/10

(52) U.S. Cl. CPC H04R 1/10
USPC 381/74

(57) ABSTRACT

A Bluetooth headset includes an earpiece and a body portion on which the earpiece portion is mounted. The earpiece portion is formed to a side surface of the body portion so that a surface of the earpiece portion substantially greater than the side surface of the body portion.

### CLAIM OF PRIORITY

This application claims the benefit under 35 U.S.C. §119(a) from a Korean Patent Application filed in the Korean Intellectual Property Office on Sep. 14, 2012 and assigned Serial No. 10-2012-0102407, the entire disclosure of which is hereby incorporated by reference.

### BACKGROUND

1. Field of the Invention

The present disclosure relates to a Bluetooth headset, and more particularly, to a slimmer Bluetooth headset.

2. Description of the Related Art

Generally, a portable mobile terminal enables voice and data communications, access the Internet, make an electronic note, and enjoy a variety of multimedia functions. More newer and innovative functions are being integrated into a smart phone.

A portable terminal is typically mounted with a module for providing wireless communication such as Radio Frequency (RF) communication, infrared communication, Bluetooth, Zigbee, etc. Among them, Bluetooth wirelessly connects portable communication devices in a short range, and enables communication between various digital devices using an RF module. In particular, a Bluetooth headset is a hand-free device which provides for wireless communication. Conventional techniques for a Bluetooth headset are disclosed in a U.S. Patent Publication Application No. 2011-0244927 (published on Oct. 6, 2011, and entitled “Apparatus and Method for Wireless Headsets”), and a Korean Patent Publication Application No. 10-2007-0055677 (published on May 31, 2007, and entitled “Wireless Headset”).

FIG. 1 is an exploded perspective view schematically showing a conventional Bluetooth headset, FIG. 2 is a diagram showing a coupled state of the Bluetooth headset shown in FIG. 1, and FIG. 3 is a front view of the Bluetooth headset shown in FIG. 1.

Referring to FIGS. 1 through 3, a conventional Bluetooth headset 10 includes an earpiece 11, a body 14, and an internal circuit board 15. The earpiece 11 is mounted on a user's ear to provide audio sound to the user. In the body 14 are mounted a Bluetooth module (not shown), the internal circuit board 15, and a battery 16. Also, the earpiece 11 is installed on a surface of the body 14.

The earpiece 11 of the Bluetooth headset 10 is mounted on wide-width surfaces 14a and 14b of the body 14. The body 14 includes a first body 12 on which the earpiece 11 is mounted, and a second body 13 coupled to the first body 12. In terms of a shape, the body 14 may include first and second surfaces 14a and 14b, which are the two wide-width surfaces 14a and 14b, along the longitudinal direction of the body 14, and a side surface 14c which has a narrow width between the first and second surfaces 14a and 14b. That is, in a state where the first body 12 and the second body 13 are coupled together, the body 14 is divided into the first and second surfaces 14a and 14b and the side surface 14c which defines the width of the first and second surfaces 14a and 14b. The earpiece 11 is provided on the wide-width surface of the first body 12, that is, the first surface 14a. On the second surface 14b on which the earpiece 11 is not mounted, a call and pairing button 21 is provided, and on the side surface 14c is positioned a power button of the Bluetooth headset 10 or a manipulation button 22 such as a transmission/reception ON/OFF button or a volume control button. If the manipulation button 22 mounted on the side surface 14c is mounted on the first surface 14a or the second surface 14b, a separate flexible circuit board (not shown) is provided for electric connection with the internal circuit board 15, such that the internal circuit board 15 and the manipulation button 22 are connected by the flexible circuit board. In particular, when the call and pairing key button 21 is positioned on one of the first surface 14a and the second surface 14b, it is generally connected with the internal circuit board 15 through the flexible circuit board due to problems in use.

However, the conventional Bluetooth headset has many drawbacks. For example, referring to the plane view of the Bluetooth headset 10 shown in FIG. 3, the shape of the conventional Bluetooth headset 10 is typically such that the earpiece 11 is mounted on the first surface 14a or second surface 14b of the body 14, which has a wide width. As a result, the conventional Bluetooth headset 10 is not easy to change in terms of its design, and positions of buttons having corresponding functions are limited. Further, a separate flexible circuit has to be provided for connection of some buttons with the internal circuit board 15 of the first and second bodies 14a and 14b. Moreover, when the user wears the Bluetooth headset 10, the wide-width surfaces 14a and 14b are placed next to the ear, such that the Bluetooth headset 10 unstably moves around the ear area during motion, causing discomfort and inconvenience to the user.

Furthermore, since the wide-width surfaces 14a and 14b are mounted on the ear, a sense of grip of the Bluetooth headset 10 is not good when the user grabs the Bluetooth headset 10 to wear or remove the Bluetooth headset 10 or manipulate buttons. Thus, when wearing or removing the Bluetooth headset 10, the user tends to grab a side surface portion of the Bluetooth headset 10, such that buttons on the side surface may erroneously operate.

### SUMMARY

Accordingly, the present invention provides a Bluetooth headset in which buttons are mounted on an internal circuit board and operate on the internal circuit board, and a button for controlling volume and a button for call and pairing are mounted on the same surface.

The present invention also provides a Bluetooth headset in which buttons are prevented from being mounted on a portion held by a user when the user wears or removes the Bluetooth headset, thus preventing erroneous operations of the buttons.

The present invention also provides a Bluetooth headset in which buttons provided in the Bluetooth headset are mounted on an internal circuit board, thereby simplifying assembly processing and reducing the cost.

According to an aspect of the present invention, a Bluetooth headset includes an earpiece and a body portion on which the earpiece portion is mounted, wherein the earpiece portion is formed to a side surface of the body portion so that a surface of the earpiece portion substantially greater than the side surface of the body portion.

According to another aspect of the present invention, there is provided a Bluetooth headset including an earpiece portion and a body portion on which the earpiece portion is mounted, wherein the earpiece portion is formed in a central-axis direction of the earpiece portion in which sound is emitted from the earpiece portion.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is an exploded perspective view schematically showing a conventional Bluetooth headset;

FIG. 2 is a diagram showing a coupled state of the Bluetooth headset shown in FIG. 1;

FIG. 3 is a front view of the Bluetooth headset shown in FIG. 1;

FIG. 4 is an exploded perspective view schematically showing a Bluetooth headset according to an exemplary embodiment of the present invention;

FIGS. 5A, 5B, and 5C are a plane view, a side cross-sectional view, and a front view of the Bluetooth headset shown in FIG. 4;

FIG. 6 is a diagram showing a state in which an internal circuit board and a battery are coupled with an earpiece portion in FIG. 4;

FIG. 7 is a rear view of the state shown in FIG. 6; and

FIG. 8 is a rear view showing a coupled state of the Bluetooth headset shown in FIG. 4.

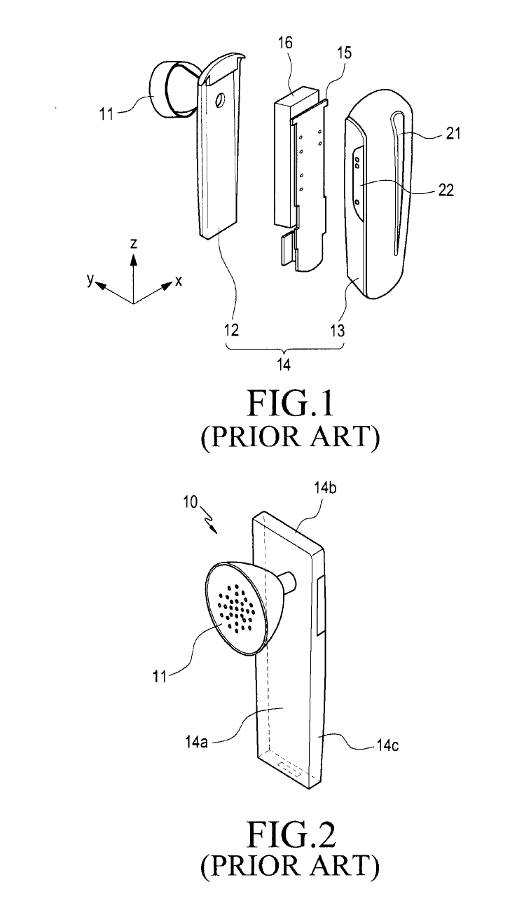

### DETAILED DESCRIPTION

Hereinafter, a Bluetooth headset according to the present invention will be described with reference to the accompanying drawings. For clarity and convenience of the description, thicknesses of lines or sizes of components shown in the drawings may be shown as being exaggerated. In addition, the same structure as in the display module fixing apparatus for the portable terminal described above will be referred to as the same reference numeral and a description thereof will be substituted by the above description.

Although ordinal numbers such as “first”, “second”, and so forth will be used in an embodiment described below, they are merely intended to distinguish objects having the same name, their order may be set arbitrarily, and the preceding description of an object may be applied to a next-order object. In addition, the following description will be made with reference to a central-axis direction of an earpiece portion (a direction in which sound is emitted, a front/rear surface direction of the earpiece portion, a Y-axis direction, and a horizontal direction), but this direction is merely a virtual direction which is set to easily recognize an installation position of each component of the Bluetooth headset, thus the reference direction may be freely changed. Moreover, the front surface of the Bluetooth headset indicates a portion through which sound of the earpiece portion is emitted, and such indication is intended to set a reference for description of the shapes or forms and structures of the earpiece portion and a body portion of the Bluetooth headset and thus may be freely changed.

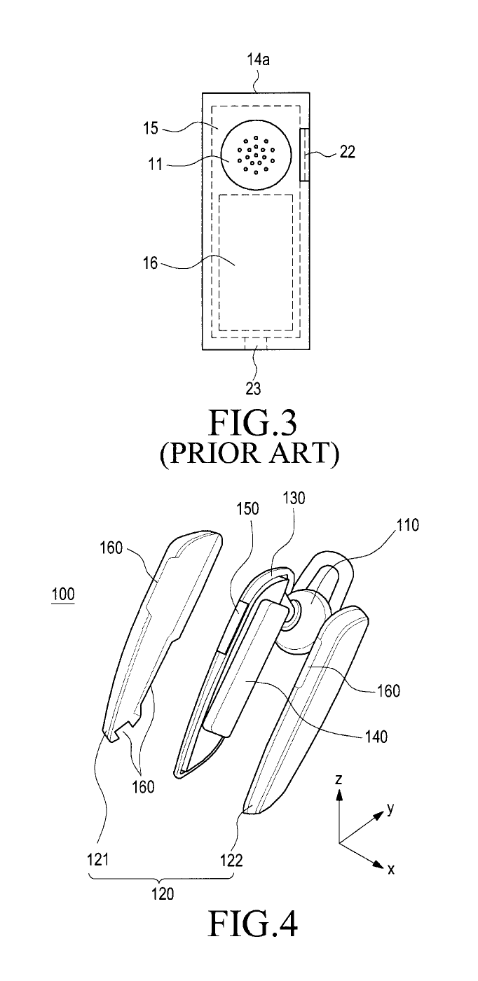

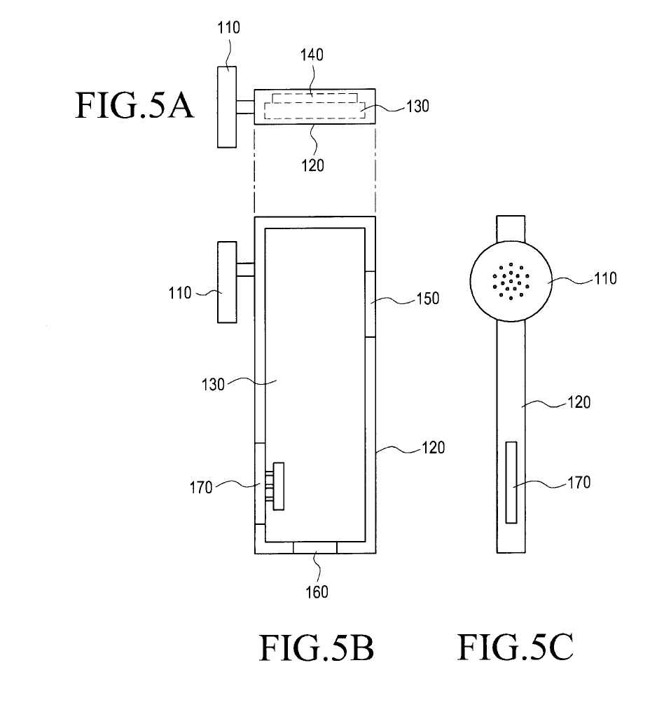

FIG. 4 is an exploded perspective view showing a Bluetooth headset according to an embodiment of the present invention, and FIGS. 5A, 5B, and 5C are a plane view, a side cross-sectional view, and a front view of the Bluetooth headset shown in FIG. 4.

Referring to FIGS. 4 through 5C, a Bluetooth headset 100 may include an earpiece portion 110, a body portion 120, an internal circuit board 130, and a battery 140. In particular, in the present invention, the earpiece portion 110 is not mounted on a wide-width surface (Y-Z plane) of the body portion 120, but is mounted on a side surface (X-Z plane) of the wide-width surface. When a portion through which sound of the earpiece portion 110 is emitted is a front surface of the Bluetooth headset 100 (see FIG. 5C), the earpiece portion 110 is mounted on a narrow-width orientation and along a longer side surface of the body portion 120 on the front surface of the Bluetooth headset 100, and the long and wide-width surface of the body portion 120 is disposed on a side surface of the Bluetooth headset 100. That is, as shown in FIG. 5C, the earpiece portion 110 is positioned to protrude from the narrow-width side surface of the body portion 120, more specifically, an upper end portion of a side surface of the body portion 120. The long and wide-width surface of the body portion 120 is formed on both side surfaces of the earpiece portion 110, such that the wide-width surface of the body portion 120 is disposed in the central-axis (Y-axis) direction of the earpiece portion 110.

Referring back to FIG. 4, the body portion 120 includes a first body 121 and a second body 122 which are shown to be divided into both sides of the earpiece portion 110 with respect to the central-axis (Y-axis) direction of the earpiece portion 110, more specifically, the Z-Y plane of the central axis (Y axis). The first body 121 is provided at one side of the earpiece portion 110 with respect to the central axis (Y axis) of the earpiece portion 110. The first body 121 has a wide-width surface defining one side surface of the Bluetooth headset 100. More specifically, the first body 121 has a wide-width surface forming a side of the Bluetooth headset 100 and a curved surface portion which is bent from the wide-width surface to form the side surface of the body portion 120 together with the second body 122. On the curved surface may be formed a groove 160 for exposing buttons 150 or connection terminals 170 provided along a side surface of the internal circuit board 130 to outside.

The second body 122 is provided at the other side of the earpiece portion 110 with respect to the central axis (Y axis) of the earpiece portion 110. The second body 122 has a wide-width surface on the side surface of the Bluetooth headset 100. More specifically, the second body 122 has a wide-width surface defining the other side of the Bluetooth headset 100 and a curved surface portion which is bent from the wide-width surface to form the side surface of the body portion 120 together with the first body 121. On the curved surface may be formed a groove for exposing the buttons 150 or the connection terminals 170 provided along the side surface of the internal circuit board 130 to outside.

As shown in FIG. 5A, referring to the plane top view of the Bluetooth headset 100, the earpiece portion 110 is mounted on a narrow-width side surface of the body portion 120. As shown in FIG. 5B, referring to the side cross-sectional view of the Bluetooth headset 100, the earpiece portion 110 protrudes from a side surface of the wide-width surface of the body portion 120. As shown in FIG. 5C, referring to the front view of the Bluetooth headset 100, the earpiece portion 110 is formed almost in a circular shape to fit into the user's ear, and a thickness of the body portion 120 on which the earpiece portion 110 is mounted (herein, the thickness of the side surface of the body portion 120) is smaller than a diameter of the earpiece portion 110. Therefore, when a mounting position of the earpiece portion 110 from which sound is emitted is a front surface of the headset 100, the long and narrow-width side surface of the body portion 120 is positioned on the front surface of the Bluetooth headset 100 and the wide-width surface of the body portion 120 forms the side surface of the Bluetooth headset 100. In particular, referring to FIGS. 5B and 5C, the buttons 150 and the connection terminals 170 as well as the earpiece portion 110 are positioned along the circumference of the narrow-width side surface of the body portion 120. The earpiece portion 110, the buttons 150, and the connection terminals 170 are mounted on the side surface of the internal circuit board 130.

The side surface of the internal circuit board 130 includes a power key 150 and/or a volume control key 150, and a call and pairing key 170. On the side surface of the internal circuit boar 130 are mounted not only the buttons 150, but also the connection terminals 170 for charging the battery 140 or inputting external information in such a way to be directly connected to the internal circuit board 130. Since the buttons 150 and the connection terminals 170 are directly connected to the internal circuit board 130, the assembly can be easily performed during manufacturing stage and thus a separate component such as a flexible circuit is not required, reducing the cost.

The buttons 150 are mounted spaced apart from the earpiece portion 110, and in particular, the call and pairing key 170 is formed spaced apart from the earpiece portion 110 on the side surface on which the earpiece portion 110 is mounted. Thus, when the user wears the Bluetooth headset 100 on the ear, the call and pairing key 170 cannot be seen from outside which in turn also improves the esthetic aspect of the Bluetooth headset 100. In the current embodiment, the call and pairing key 170 are mounted on the same plane as the side surface of the body portion 120 on which the earpiece portion 110 is mounted, and the volume control key 150 or the power key 150 is provided on a side surface facing the side surface on which the earpiece portion 110 is mounted. However, the positions of the buttons 150 are not limited thereto. In alternate embodiment, the buttons 150 may be mounted in any position of the body portion 120 in the current embodiment in which the earpiece portion 110 and the body portion 120 are disposed in the same axis direction, and the buttons 150 may also be mounted on the wide-width surface of the body portion 120 by using a separate flexible circuit.

On the wide-width surfaces of the first body 121 and the second body 122, more specifically, both side surfaces of the Bluetooth headset 100 may be further formed a grip surface (not shown) for allowing the user to easily hold the Bluetooth headset 100 and preventing slippage. The shape of the grip surface may be variously changed. For example, a plurality of protrusions may be formed on a portion gripped by the user or a separate member formed of a rubber material may be attached to the portion.

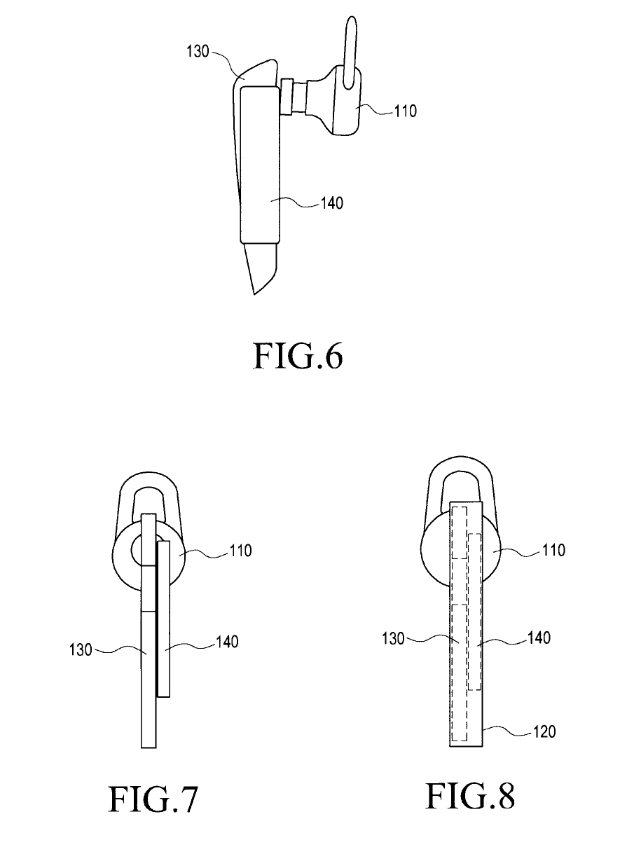

FIG. 6 is a diagram showing a side surface of the Bluetooth headset 100 shown in FIG. 4 in which the internal circuit board 130 and the battery 140 are coupled with the earpiece portion 110, and FIG. 7 is a diagram schematically showing a rear surface of the state shown in FIG. 6.

Referring to FIGS. 6 and 7, the internal circuit board 130 and the battery 140 are mounted inside the body portion 120, such that the internal circuit board 130 and the battery 140 are stacked to face each other in the central-axis (Y-axis) direction of the earpiece portion 110. More specifically, the wide-width surfaces of the internal circuit board 130 and the battery 140 are disposed on the both side surfaces of the earpiece portion 110, and a portion corresponding to side surfaces of the internal circuit board 130 and the battery 140 face the rear surface of the earpiece portion 110. The earpiece portion 110 is directly mounted on the side surface of the internal circuit board 130 to receive sound. The battery 140 is disposed in the same direction as the internal circuit board 130 to face a surface of the internal circuit board 130, and supplies power to the internal circuit board 130.

FIG. 8 is a rear view showing a coupled state of the Bluetooth headset 100 shown in FIG. 4. As shown, as the first body 121 and the second body 122 are engaged on the respective surfaces of the internal circuit board 130 and the battery 140, the internal circuit board 130 and the battery 140 are mounted inside the first and second bodies 121 and 122, respectively. Once the first body 121 and the second body 122 are coupled in an engaged manner with each other, the first body 121, the internal circuit board 130, the battery 140, and the second body 122 are stacked sequentially in that order. The both side surfaces of the Bluetooth headset 100 form a wide-width surface, and on the front surface of the Bluetooth headset 100 are formed the long and narrow-width side surface of the body portion 120 as well as the earpiece portion 110. That is, the wide-width surface of the body portion 120 forms the both side surfaces of the Bluetooth headset 100 extends in the central-axis (Y-axis) direction of the earpiece portion 110 to form a wide-width surface.

The Bluetooth headset 100 structured as described above is provided with the battery 140 at a side of the internal circuit board 130 and the earpiece portion 110, the buttons 150, and the connection terminals 170 which are mounted along the side surface of the internal circuit board 130. As a result, when viewed from the front surface of the Bluetooth headset 100, the Bluetooth headset 100 has a shape as shown in FIG. 7. In this state, when the first body 121 and the second body 122 are engaged with each other on the both side surfaces of the earpiece portion 110 such that the internal circuit board 130 and the battery 140 are disposed inside the first body 121 and the second body 122, respectively, the shape of the Bluetooth headset 100 is such that the long and narrow-width side surface of the body portion 120 is positioned on the front surface of the Bluetooth headset 100 and the earpiece portion 110 protrudes from the side surface of the body portion 120. Thus, the Bluetooth headset 100 has a long shape having a smaller width than the radius of the earpiece portion 110.

As is apparent from the foregoing description, the wide-width surface of the body portion of the Bluetooth headset is formed long in the central-axis direction of the earpiece portion, thus implementing a unique design which is different from the conventional Bluetooth headset discussed earlier.

The configuration according to the teachings of the present invention as described above address the drawbacks associated with the conventional headset. For example, the user can wear the Bluetooth headset on the ear or remove it from the ear while holding the wide-width surface of the Bluetooth headset, thus making it easy for the user to wear or remove the Bluetooth headset.

Moreover, the earpiece portion of the Bluetooth headset is mounted to protrude from the side surface of the wide-width surface of the body portion, and the buttons or connection terminals are mounted along the side surface, thereby realizing various designs of the Bluetooth headset and improving the esthetic aspect of the Bluetooth headset.

Further, the buttons or the connection terminals are mounted on the internal circuit board, thereby simplifying assembly and reducing the manufacturing cost.

The apparatuses and methods of the disclosure can be implemented in hardware, and in part as firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed disclosure. Under the broadest reasonable interpretation, the appended claims constitute statutory subject matter in compliance with 35 U.S.C. §101.

The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

The present invention is not limited by the foregoing embodiment and the accompanying drawings because various substitutions, modifications, and changes can be made by those of ordinary skill in the art without departing from the technical spirit of the present invention.

What is claimed is:

1. A Bluetooth headset comprising:
an earpiece portion; and
a body portion on which the earpiece portion is mounted,
wherein the earpiece portion is formed to a side surface of the body portion so that the surface of the earpiece portion substantially greater than the side surface of the body portion.

2. The Bluetooth headset of claim 1, wherein the body portion includes a first body provided at a side of the earpiece portion with respect to a central axis of the earpiece portion and
a second body coupled to the first body and provided at the other side of the earpiece portion.

3. The Bluetooth headset of claim 1, further comprising at least one button and at least one connection terminal are positioned along the side surface of the body portion.

4. The Bluetooth headset of claim 1, further comprising an internal circuit board and a battery for supplying power to the internal circuit board disposed inside the body portion.

5. The Bluetooth headset of claim 4, further comprising at least one button and at least one connection terminal mounted along a circumference of the internal circuit board.

6. The Bluetooth headset of claim 5, wherein the at least one button comprises one of a call and pairing key, a volume control key, and a power key.

7. The Bluetooth headset of claim 6, wherein the call and pairing key is mounted spaced apart from the earpiece portion on the side surface on which the earpiece portion is mounted.

8. The Bluetooth headset of claim 6, wherein the volume control key and the call and pairing key are positioned on the same plane as the side surface on which the earpiece portion is mounted.

9. The Bluetooth headset of claim 2, further comprising a grip surface formed on the surfaces of the first body and the second boy.

10. The Bluetooth headset of claim 2, wherein when the first body and the second body are coupled together, a mounting surface of the earpiece portion has a smaller width than a size of the earpiece portion.

11. A Bluetooth headset comprising:
an earpiece portion; and
a body portion on which the earpiece portion is mounted,
wherein the earpiece portion is formed in a central-axis direction of the earpiece portion in which sound is emitted from the earpiece portion.

12. The Bluetooth headset of claim 11, further comprising an internal circuit board and a battery for supplying power to the internal circuit board disposed inside the body portion along the central-axis direction of the earpiece portion.

13. The Bluetooth headset of claim 11, wherein the body portion includes
a first body positioned at a side of the earpiece portion with respect to a central axis of the earpiece portion and
a second body which is engaged with the first body and provided at the other side of the earpiece portion,
wherein, when the first body and the second body are coupled together, a mounting surface of the earpiece portion has a smaller width than a size of the earpiece portion.

14. The Bluetooth headset of claim 12, further comprising at least one button and at least one connection terminal are positioned along the side surface of the body portion.

15. The Bluetooth headset of claim 11, further comprising at least one button and at least one connection terminal are positioned along the side surface of the body portion.

16. The Bluetooth headset of claim 11, further comprising an internal circuit board and a battery for supplying power to the internal circuit board disposed inside the body portion.

17. The Bluetooth headset of claim 16, further comprising at least one button and at least one connection terminal mounted along a circumference of the internal circuit board.

18. The Bluetooth headset of claim 15, wherein the at least one button comprises one of a call and pairing key, a volume control key, and a power key.

19. The Bluetooth headset of claim 18, wherein the call and pairing key is mounted spaced apart from the earpiece portion on the side surface on which the earpiece portion is mounted.

20. The Bluetooth headset of claim 18, wherein the volume control key and the call and pairing key are positioned on the same plane as the side surface on which the earpiece portion is mounted.
